(19) United States
(12) Patent Application Publication
(10) Pub. No.: US 2013/0290611 A1
(43) Pub. Date: Oct. 31, 2013

(54) POWER MANAGEMENT IN A FLASH MEMORY

(71) Applicant: VIOLIN MEMORY INC., (US)

(72) Inventors: Dan Biederman, San Jose, CA (US); Jon C.R. Bennett, Sudberry, MA (US)

(21) Appl. No.: 13/798,942

(22) Filed: Mar. 13, 2013

Related U.S. Application Data
(60) Provisional application No. 61/614,778, filed on Mar. 23, 2012.

(51) Int. Cl. G06F 12/02; G06F 3/06

(52) U.S. Cl. CPC G06F 12/0246; G06F 3/0689
USPC 711/103; 711/114

(57) ABSTRACT

The peak power requirements for operations performed on a FLASH memory circuit vary substantially, with reading, writing and erasing requiring increasing levels of power. When the memory is operated to improve performance using erase hiding, the performance of write or erase operations where the time periods for such operations can overlap results in increased peak power requirements. Controlling the time periods during which modules of a RAID group are permitted to perform erase operations, with respect to other modules in other RAID groups may smooth out the requirements. In addition, such scheduling may lead to improved efficiency in using shared data buses.

This application claims the benefit of U.S. 61/614,778, filed on Mar. 23, 2012, which is incorporated herein by reference.

### BACKGROUND

Memories used in computing and communications systems include, but are not limited to, random access memory (RAM) of all types (e.g., S-RAM, D-RAM); programmable read only memory (PROM); electronically alterable read only memory (EPROM); flash memory (FLASH), magnetic memories of all types including Magnetoresistive Random Access Memory (MRAM), Ferroelectric RAM (FRAM or FeRAM) as well as NRAM (Nanotube-based/Nonvolatile RAM) and Phase-change memory (PRAM), and magnetic disk storage media. Other memories which may become suitable for use in the future include quantum devices and the like.

The power consumption of a memory depends on the type of memory and the specific operation being performed in the memory. So, the power requirements of each memory chip may vary with time, and in an array of memory circuits, the total power consumption may have substantial variations depending on the particular usage case. Such power fluctuations may be undesirable as the peak currents need to be accommodated by the connections between the power source and the memory circuits and localized overheating may occur.

### SUMMARY

A device is disclosed comprising a controller configured to operate a memory device, having a plurality of memory circuits, each memory circuit performing operations having at least a high power requirement and a low power requirement. A group of the plurality of memory circuits may be selected to form a RAID group having erase hiding. Two or more RAID groups may be configured such that a memory circuit performing a high power requirement operation in each RAID group is connected to power supply circuits such that the number of memory circuits performing overlapping high power operations and connected to a power supply circuit of the power supply circuits is limited.

In an aspect, the high power operation may be an erase or write operation performed by a FLASH memory circuit. The lower power operation may be a read operation performed by a FLASH memory circuit. The device of may he operated such that the number of high power operations that completely overlap in time is limited.

Erase hiding comprises configuring the controller to write a stripe of data, including parity data for the data, to a group of memory circuits comprising a RAID group; and read the stripe of data from the RAID group such that an erase operation performed on a memory block of a memory circuit of the RAID group memory is scheduled such that that sufficient data or parity data can be read from the memory circuits to return the data stored in the memory stripe of the RAID group in response to a read request, without a time delay due to the erase operation.

In an aspect, an erase operation is scheduled for the memory circuits if a stripe of a RAID group such that only one memory circuit of the stripe is performing an erase operation when single parity of the data is stored with the data. In yet another aspect, erase operations are scheduled such that two or less such erase operations are scheduled to be overlapping when dual parity data is stored with the data.

In another aspect, a memory device is disclosed having a controller configured to operate a memory device having a plurality of memory circuits, each memory circuit sharing a common bus between the controller and each of the plurality of memory circuits. A first memory circuit and a second memory circuit are controlled such that an operation performed on a first of the memory circuits is scheduled to permit transfer of data on the bus to a second memory circuit.

In an aspect, the operation performed on the first memory circuit is one of an erase or a write operation, and the transfer of data to the second memory circuit is data to be subsequently written to the second memory circuit. The first memory circuit and the second memory circuit are a first plane of a FLASH memory circuit and a second plane of a FLASH memory circuit.

When a plurality of memory circuits share a common bus between the memory circuits and the controller and the controller schedules the operations to be performed by the memory circuits such that transfer operations may performed by a memory circuit during a time period when a first memory circuit is performing a erase or write information and the memory circuit to which the data is being transferred is not performing the erase or write information.

In an aspect, the erase or write operations scheduled for the memory circuits of the plurality of memory circuits are scheduled such that a data transfer operation from the controller is permitted to each of the memory circuits of the plurality of memory circuits before a second erase or write operation is scheduled for any of the memory circuits sharing the bus. The bus may be configured to transmit data from the memory circuits to the controller when the bus is not being used to transfer data to any of the memory circuits.

In yet another aspect, a memory device is disclosed comprising a controller configured to operate a memory device, having a plurality of memory circuits, each memory circuit performing operations having at least a high power requirement and a low power requirement and a group of the plurality of memory circuits is selected to form a RAID group having erase hiding. The controller may be operated to selectively inhibit operations of a memory circuits of the RAID group associated with the high power requirement.

In an aspect, the number of memory circuits of the RAID group having simultaneously inhibited operations may be less than or equal to the number of redundant data blocks associated with a stripe of the RAID group.

A method of operating a memory device is disclosed, comprising the steps of: configuring a controller to operate a memory device, wherein the memory device has a plurality of memory circuits, each memory circuit performing operations having at least a high power requirement and a low power requirement, and a group of memory circuits are configured to form a RAID group having erase hiding.

The method further comprises configuring two or more RAID groups such that a memory circuit performing a high power requirement operation in each RAID group is connected to power supply circuits such that the number of memory circuits performing overlapping high power operations and connected to a power supply circuit of the power supply circuits is limited.

A computer program product, stored on a non-volatile media, is disclosed, comprising: instructions configuring a controller to operate a memory device, wherein the memory device has a plurality of memory circuits, each memory circuit performing operations having at least a high power requirement and a low power requirement. The controller is operative to configure a group of the plurality of memory circuits to form a RAID group having erase hiding; and, two or more RAID groups are operated such that a memory circuit performing a high-power-requirement operation in each RAID group may be connected to power supply circuits such that the number of memory circuits performing overlapping high-power-requirement operations and connected to a power supply circuit of the power supply circuits is limited.

### BRIEF DESCRIPTION OF THE DRAWINGS

FIG. 1 is a block diagram showing a server in communication with a memory system;

FIG. 2 is a block diagram of the memory system having a plurality of memory modules configured for operation as a RAID group;

FIG. 3 is a block diagram of a memory system having a branching tree architecture, where the modules forming the RAID group are dispersed at selectable location in the tree;

FIG. 4 is a timing diagram for a RAID group configured for erase hiding;

FIG. 5 A is a representation of the time history of peak power requirements when memory modules are connected to a common power source and perform high power operations simultaneously; and, B is a representation of the time history of peak power requirements wherein the memory modules connected to a common power source perform high power operations according to a schedule;

FIG. 6 is a representation of the organization of data into pages and blocks for a FLASH circuit having two die, each with two planes;

FIG. 7 is a block diagram of a FLASH memory circuit;

FIG. 8 shows the operation of each of the planes of 4 die on a common time base, where: A; loading data and writing (or erasing) is shown; and, B with the addition of reading operations

FIG. 9 shows an indicative power consumption of 4 individual die and the total power consumption for the 4 die on a common time base where A is the power consumption when the die operate simultaneously: and, B is the power consumption when the die operate in accordance with the example of FIG. 8A.

### DETAILED DESCRIPTION

Exemplary embodiments may be better understood with reference to the drawings, but these embodiments are not intended to be of a limiting nature. Like numbered elements in the same or different drawings perform equivalent functions. Elements may be either numbered or designated by acronyms, or both, and the choice between the representation is made merely for clarity, so that an element designated by a numeral, and the same element designated by an acronym or alphanumeric indicator should not be distinguished on that basis.

When describing a particular example, the example may include a particular feature, structure, or characteristic, but every example may not necessarily include the particular feature, structure or characteristic. This should not be taken as a suggestion or implication that the features, structure or characteristics of two or more examples, or aspects of the examples, should not or could not be combined, except when such a combination is explicitly excluded. When a particular aspect, feature, structure, or characteristic is described in connection with an example, a person skilled in the art may give effect to such feature, structure or characteristic in connection with other examples, whether or not explicitly set forth herein.

It will be appreciated that the methods described and the apparatus shown in the figures may be configured or embodied in machine-executable instructions; e.g., software, hardware, or in a combination of both. The instructions can be used to cause a general-purpose computer, a special-purpose processor, such as a DSP or array processor, an application specific integrated circuit (ASIC), a field programmable gate array (FPGA) or the like, that is programmed with the instructions to perform the operations described. Alternatively, the operations might be performed by specific hardware components that contain hardwired logic or firmware instructions for performing the operations described, or may be configured to so, or by any combination of programmed computer components and custom hardware components, which may include analog circuits.

The methods may be provided, at least in part, as a computer program product that may include a machine-readable medium having stored thereon instructions which may be used to program a computer (or other electronic devices), or a FPGA, or the like, to perform the methods. For the purposes of this specification, the terms “machine-readable medium” shall be taken to include any medium that is capable of storing or encoding a sequence of instructions or data for execution by a computing machine or special-purpose hardware and that cause the machine or special purpose hardware to perform any one of the methodologies or functions of the present invention. The term “machine-readable medium” shall accordingly be taken include, but not be limited to, solid-state memories, optical and magnetic disks, magnetic memories, optical memories, or other functional equivalents. The software program product may be stored or distributed on one medium and transferred or re-stored on another medium for use.

For example, but not by way of limitation, a machine readable medium may include: read-only memory (ROM); random access memory (RAM) of all types (e.g., S-RAM, D-RAM); programmable read only memory (PROM); electronically alterable read only memory (EPROM); magnetic random access memory; magnetic disk storage media; FLASH; or, other memory type that is known or will be developed, and having broadly the same functional characteristics.

Furthermore, it is common in the art to speak of software, in one form or another (e.g., program, procedure, process, application, module, algorithm or logic), as taking an action or causing a result. Such expressions are merely a convenient way of saying that execution of the software by a computer or equivalent device causes the processor of the computer or the equivalent device to perform an action or a produce a result, as is well known by persons skilled in the art.

A memory system may be comprised of a number of functional elements, and terminology may be introduced here so as to assist the reader in better understanding the concepts disclosed herein. However, the use of a specific name with respect to an aspect of the system is not intended to express a limitation on the functions to be performed by that named aspect of the system. Except as specifically mentioned herein, the allocation of the functions to specific hardware or software aspects of the system is intended for convenience in discussion, as a person of skill in the art will appreciate that the actual physical aspects and computational aspects of a system may be arranged in a variety of equivalent ways. In particular, as the progress in the electronic technologies that may be useable for such a system evolves, the sizes of individual components may decrease to the extent that more functions are performed in a particular hardware element of a system, or that the scale size of the system may be increased so as to encompass a plurality of system modules, so as to take advantage of the scalability of the system concept. All of these evolutions are intended to be encompassed by the recitations in the claims.

The memory system may comprise, for example, a controller, which may be a RAID controller, and a bus system connecting the controller with a plurality of memory modules. The memory modules may comprise a local controller, a buffer memory, which may be a dynamic memory such as DRAM, and a storage memory, such as NAND flash.

“Bus” or “link” means a signal line or a plurality of signal lines, each having one or more connection points for “transceiving” (i.e., either transmitting, receiving, or both). Each connection point may connect or couple to a transceiver (i.e., a transmitter-receiver) or one of a single transmitter or receiver circuit. A connection or coupling is provided electrically, optically, magnetically, by way of quantum entanglement or equivalents thereof. Other electrical connections, by the same or similar means are used to provide for satisfaction of such additional system requirements as power, ground, auxiliary signaling and control, or the like. Such additional connections are occasionally described so as to clarify the description, however such additional connections are well known to persons skilled in the art, and the lack of description of these connections in any example should not be taken to exclude their inclusion.

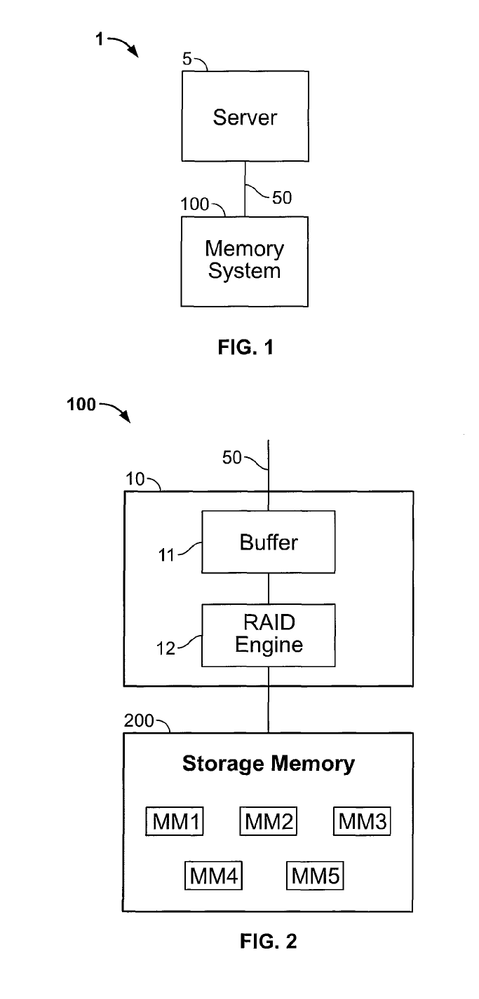

An example computing system 1, shown in FIG. 1, may comprise a server 5, or other source of requests, to perform operations on a memory system 100. The most common operations to be performed are reading of data from an address in the memory system 100 for return to the server 5, or writing data provided by the server 5 to an address in the memory system 100. The data to be read or written may comprise, for example, a single address or a block of addresses, and may be described, for example, by a logical block address (LBA) and a block size.

In describing the operation of the system, only occasionally are error conditions and corner cases described herein. This is done to simplify the discussion so as not to obscure the overall concept of the system and method described herein. During the course of the system design and development of the computer program product that causes the system to perform the functions described herein, a person of skill in the art would expect to identify such potential abnormal states of operation, and would devise algorithms to detect, report and to mitigate the effects of the abnormalities. Such abnormalities may arise from hardware faults, program bugs, the loss of power, improper maintenance, or the like.

The logical address of the data may be specified in a variety of ways, depending on the architecture of the memory system 100 and the characteristics of the operating system of the server 5. The logical memory address space may be, for example, a flat memory space having a maximum value equal to the maximum number of memory locations that are being, or could be, made available to the server 5 or other device using the memory system 100. Additional memory locations of the memory system 100 may be reserved for internal use by the memory system 100. Alternative addressing schemas may be used which may include the assignment of logical unit numbers (LUN) and an address within the LUN. Such LUN addressing schemes are eventually resolvable into a specific logical address LBA within the overall memory system 100 address space, if such an abstraction has been used. The address resolution may be performed within the memory system 100, in the server 5, or elsewhere. For simplicity, the descriptions herein presume that a LUN and address therein has been resolved into a logical address within a flat memory space of the memory system 100.

A computing system may use, for example, a 64-bit binary address word resulting in a theoretical byte-addressable memory space of 16 exabytes (16×2⁶⁰ bytes). Legacy computing systems may employ a 32-bit binary address space and are still in use. A 64-bit address space is considered to be adequate for current needs, but should be considered to be for purposes of illustration rather than a limitation, as both smaller and larger size address words may be used. In some cases, the size of an address word may be varied for convenience at some level of a system where either a portion of the address word may be inferred, or additional attributes expressed.

The logical address value LBA may be represented in decimal, binary, octal, hexadecimal, or other notation. A choice of representation made herein is not intended to be limiting in any way, and is not intended to prescribe the internal representation of the address for purposes of processing, storage, or the like.

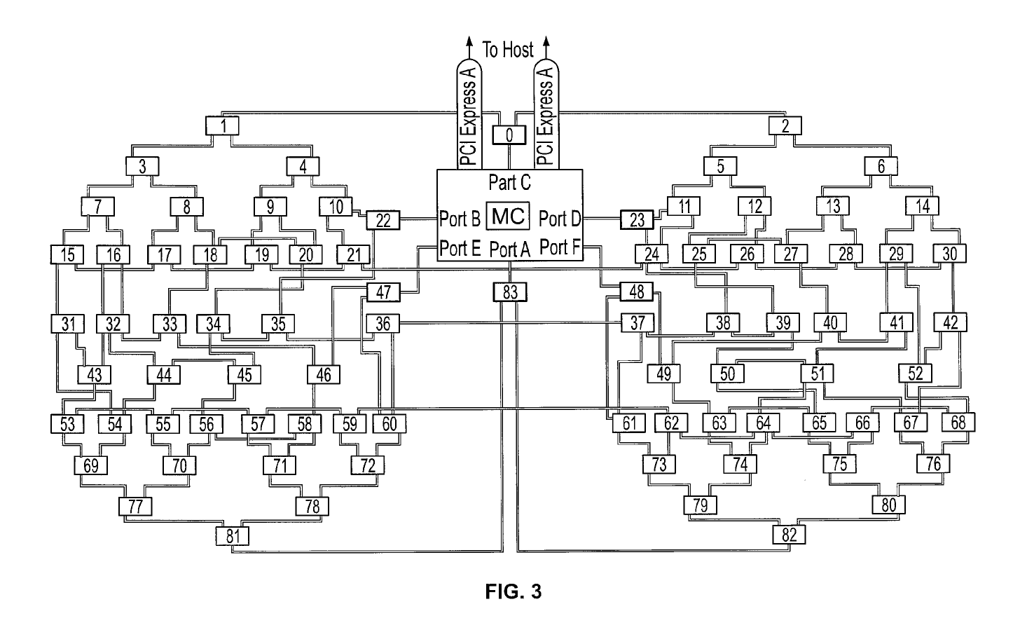

Commands and data may be received by or from, or requested by or from the memory system 100 (FIG. 2) by the server 5 over the interface 50 based on the number of requests that may be accommodated in the RAID controller 10 (RC) of the memory system 100. The RC may have an input buffer 11 that may queue a plurality of commands or data that are to be executed or stored by the memory system 100. The RAID engine 12 may de-queue commands (e.g., READ, WRITE) and any associated data from the input buffer 11 and the logical block address LBA of the location where the data is to be stored, or is stored may be determined. The RC 10 may decompose the logical block address and the block of data into a plurality of logical addresses, where the logical address of each portion of the original block of data may be associated with a different storage module so that the storage locations for each of the plurality of sub-blocks thus created appropriately distributes the data over the physical storage memory 200, so that a failure of a hardware element may not result in the loss of more of the sub-blocks of data that can be corrected by the RAID approach being used.

For example, the RC engine 12 may compute a parity over the entire block of data, and store the parity data as a sub-block on a storage module selected such that a failure of a storage module does not compromise the data of the data block being stored. In this manner, the parity data may be used to reconstruct the data of a failed storage module. That is, the remaining sub-blocks (strips) and the parity data strip may be used to recover the data of the lost sub-block. Alternatively, if the storage module on which the parity data is stored fails, all of the sub-blocks of the block of data remain available to reconstruct the parity sub-block. Sub-blocks of a block of data may also be called “chunks” or “strips.” A person of skill in the art would recognize that this applies to a variety of types of memory technologies and hardware configurations.

In an example, there may be 5 memory modules, as shown in FIG. 2, of which four modules may be allocated to store sub-blocks of the data block having a block address LBA and a size B. The fifth module may store the parity data for each block of data. A group of memory modules that are used to store the data, which may include parity data of the group may be termed a RAID group or stripe. The number of sub-blocks, and the number of memory modules (MM) in the RAID group may be variable and a variety of RAID groups may be configured from a physical storage memory system; a plurality such other configurations may exist contemporaneously. The particular example here is used for convenience and clarity of explanation.

The RAID group may be broadly striped across a large memory array, for example as described in U.S. patent application Ser. No. 12/901,224, “Memory System with Multiple Striping”, which is commonly assigned and is incorporated herein by reference. Different RAID striping modalities may be interleaved in the memory address space.

The RAID controller may use the logical block address LBA, or some other variable to assign the command (READ, WRITE) to a particular RAID group (e.g., RG1) comprising a group of memory modules that are configured to be a RAID group. Particular organizations of RAID groups may be used to optimize performance aspects of the memory system for a particular user.

In an example, the logical block address may be aligned on integral 4K byte boundaries, the increment of block address may 4K and the data may be stored in a RAID group. Let us consider an example where there are up to 16 RAID groups (0-Fh), and a mapping of the logical block address to a RAID group is achieved by a simple algorithm. A logical block address may be: 0x 0000000000013000. The fourth least significant nibble (3) of the hexadecimal address may be used to identify the RAID group (from the range 0-F, equivalent to RAID groups 1-16). The most significant digits of the address word (in this case 0x000000000001) may be interpreted as a part of the logical address of the data in a RAID group (the upper most significant values of the logical address of the data on a module in a RAID group); and the last three nibbles (in this case0x 000) would be the least significant values of the logical address of the data stored in RAID group 3 (RG3). The complete logical address block address for the data in RG3 would be 0x 000000000001000 (in a situation where the digit representing the RAID group is excised from the address word) for all of the MM in the RAID group to which the data (and parity data) is stored.

The routing of the commands and data (including the parity data) to the MM of the memory system 100 depends on the architecture of the memory system.

The memory system shown in FIG. 3 comprises 84 individual memory modules connected in double-ended trees and ancillary roots that are serviced by memory controllers to form a “forest”. Memory modules MM0 and MM83 may be considered as root modules for a pair of double-ended binary trees. Memory modules MM1, MM2, MM81 and MM82 may be considered to be root memory modules of individual trees in the memory. The MC, and memory modules MM22, MM23, MM47 and MM48 may act as root modules for portions of the memory system tree so as to provide further connectivity in the event of a memory module failure, or for load balancing. Configurations with additional root modules so as to form a cluster of forests are also possible.

The memory controller MC may connect to the remainder of the memory system 100 by one or more PCIe channels, or other high speed interfaces. Moreover, the memory controller itself may be comprised of a plurality of memory controllers.

The individual memory modules MM, or portions thereof, may be assigned to different RAID groups (RG).

TABLE 1

| RAID Group | C0 | C1 | C2 | C3 | P |
|---|---|---|---|---|---|
| 0 | | | | | |
| 1 | | | | | |
| 2 | | | | | |
| 3 | MM23 | MM1 | MM16 | MM17 | MM20 |
| 4 | | | | | |
| . | | | | | |
| . | | | | | |
| . | | | | | |
| 15 | | | | | |

For clarity, only the memory modules currently assigned to one RAID group (RG3) are shown in Table 1, as an example. As there are 16 RAID groups in this example, each associated with 5 MMs, a total of 80 MMs would be associated with the currently configured RAID groups. Since the tree structure of FIG. 3 may accommodate 84 MM, this can permit up to 4 MM to be allocated as spare modules, immediately available should a MM fail.

Table 1 provides the basis for the configuration of a routing table so that a routing indicator may be established between ports (labeled A-F in FIG. 3) of the memory controller MC and the destination module MM for a sub-block of the block of data, or the parity sub-block thereof, to be stored at an address in the selected RG.

This routing indicator is used to determine the path from the MC to the individual MM. The routing may be determined, for example, at the memory controller MC and the routing executed switches in the MMs along the path, as described in Ser. No. 11/405,083, “Interconnection System”, which is commonly assigned and is incorporated herein by reference. Other approaches can also be used to cause the commands and data to be forwarded form the MC to the appropriate MMs, and returned to the MC from the MMs.

Each memory module MM may store the data in a physical address related to the logical block address (LBA). The relationship between the LBA and the physical address depends, for example, on the type of physical memory used and the architecture of memory system and subsystems, such as the memory modules. The relationship may be expressed, for example, as an algorithm, or by metadata.

Where the memory type is NAND FLASH, for example, the relationship between the logical address and the physical address may be mediated by a flash translation layer (FTL). The FTL provides a correspondence between the data logical block address LBA and the actual physical address PA (also termed PBA, but referring to a memory range having the base address and being a page in extent, corresponding to the size of the LBA, for example) within the FLASH chip where the data is stored. The FTL may account, for example, for such artifacts in FLASH memory as bad blocks, and for the physical address changes of stored data associated with garbage collection and wear leveling, which functions may be desired to be accommodated while the memory system is operating.

In the present example of operation, a 4K byte data block is separated into four (4) 1K chunks, and a parity P of size 1K computed over the 4 chunks. The parity P may be used for RAID reconstruction when needed, or may also be used for implementing “erase hiding” in a FLASH memory system, as described in a U.S. patent application Ser. No. 12/079,364, “Memory Management System and Method”, which is commonly assigned and is incorporated herein by reference. Other parity schemes may be used, and accommodate situations where multiple modules have failed, or where performance may be maintained in failure modes.

When the data is received at the destination MM, the logical block address LBA is interpreted so as to store or retrieve the data from the physical memory PBA as mediated by the FTL. Since the chunks stored in the MM of a RAID group RG have an ordered address relationship to the data block of which they are a constituent, the storage of the chunk on a MM may be adequately described by the logical block address (LBA) of the data block as interpreted by the system MC.

Since RAIDed systems are normally intended to reconstruct data only when there is a failure of one of the hardware modules, each of the data sub-blocks that is returned without an error message would be treated as valid.

The use of the term “module” has a meaning that is context dependent. In this example, the meaning is that the level of partitioning the system is governed by the desire to only store as many of the sub-blocks (chunks) of data of a data block on a particular hardware element as can be corrected by the RAID approach chosen, in the case where the “module” has failed. In other contexts, which may be within the same memory system, a module may have a different meaning. For example, when the concept of “erase hiding” is being used, the module may represent a portion of memory that is scheduled for a write or an erase period of operation at a particular time. There may be more than one “erase hiding” module in a

module defined for RAID. That this is reasonable may be understood by considering that a memory module, such as is used in FIG. 3 for example, may have a switch, processor and cache memory on each module, as well as bus interfaces, and that a failure of one or more of these may render the memory module inoperative. However, for the purposes of managing write or erase time windows, the memory chips on the memory module may be controlled in smaller groups.

A person of skill in the art would understand that a block of memory cells and a block of data are not necessarily synonymous. NAND FLASH memory, as is currently available, may be comprised of semiconductor chips organized as blocks (that is, a contiguous physical address space; which may not be the same as a “block” of user data) that are subdivided into pages, and the pages may be subdivided into sectors. These terms have a historical basis in the disk memory art; however, a person of skill in the art will understand the differences when applied to other memory types, such as NAND FLASH.

Generally a block of memory (which may be 128 Kbytes in size) may be written on a sequential basis with a minimum writable address extent of a sector or a page of the physical memory, and generally the sector or page may not be modified (with changed data) unless the entire block of pages of the physical memory is first erased. However, a block of data when used in the context of LBA is an aspect of a data structure and is more properly thought of as a logical construct, which may correspond, for example, to a page of the physical memory).

To accommodate the situation where the logical address of a data element does not generally simply correspond to the physical address in the memory where the corresponding data may be found, a intermediary protocol, a FTL, may be implemented, so that metadata provides for a mapping of the logical data address to the physical data address, while also accommodating needed housekeeping operations.

At the MM, if the memory technology is NAND FLASH, a block erase time may be of the order of 10 s of ms, and write (program) times may be of the order of several milliseconds. Each of these times may tend to increase, rather than decrease as this technology evolves, as manufacturers may trade the number of bits per cell against the time to program or write data to a cell for economic reasons. Read operations are relatively speedy as compared with write/erase operations and are perhaps 250 μs for commercially available components today. Improvements in access bus architecture may further reduce the read time. Depending on the organization of the memory chips on a MM, and the operation of the MM, the gap between the performance of individual memory chips and the desired performance of the MM may be mitigated. In particular, the erase/write hiding technology previously described could be used at the MM level, considering the MM itself as a memory array. Here, the data may be further RAIDed, for the purpose of write/erase hiding. Such techniques may be used in addition to the methods of eliminating redundant reads or writes as described herein.

The read, write and erase times that are being used here are merely exemplary, so as to provide an approximate time scale size so as to better visualize the processes involved. The relative relationship is that the time to perform the operation is, in order of increasing time for a particular memory: read, write, and erase. The differing NAND memory systems currently being used are SLC, MLC, and TLC, being capable of storing one, two, or three bits per cell, respectively. Generally the time scales for all operations increase as the number of bits per cell increase, however, this is not intended to be a limitation on the approach described herein.

The system and method described herein may be controlled and operated by a software program product, the product being stored on a non-volatile machine-readable medium. The software product may be partitioned and transferred to the memory system so as to be resident in, for example, the RC, MC, MM and elsewhere so as to cooperatively implement all of part of the functionality described. The preceding description used a data block of 4 KB for illustrative purposes. While it appears that many new designs of data processing systems are using this block size, both larger and smaller block sizes may be used. A system optimized for 4 KB data blocks may be configured to operate with legacy systems using block sizes of, for example, 128 bytes, which may be of the size order of a cache line. Page sizes of, for example, 256, 512, 1024 and 2048 bytes may also be used, and will be recognized as previously used in disk systems or other memory systems. The smallest writable page size of currently available mass market NAND FLASH is 512 bytes, and writes of less than 512 bytes may either be padded with a constant value, or shared with other small data blocks. When the data block is read, even if a larger data block is read from the FLASH, the desired data may be extracted from the output buffer of the device. When servicing the sub-optimum block sizes, the number of read and write operations may be increased relative to the example described above.

The level of the system and sequence of performing the various methods described herein may be altered depending on the performance requirements of a specific design and is not intended to be limited by the description of specific illustrative examples.

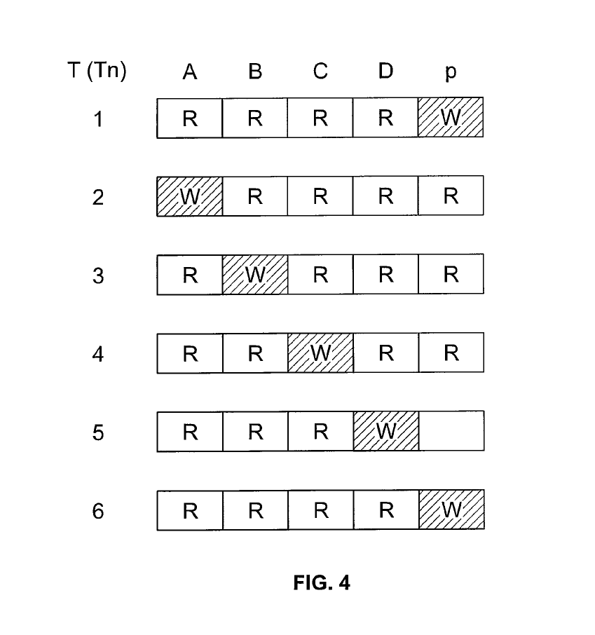

Returning to the simple configuration of FIG. 3, the concept of erase (or write) hiding, as disclosed in U.S. Ser. No. 12/079, 364, “Memory Management System and Method, which is commonly assigned and is incorporated herein by reference, may be summarized in an example shown in FIG. 4. In this example, each of the five memory modules MM are assigned a non-overlapping time interval Te or Tw where erase or write operations, respectively, may be performed. Outside of this interval, only read operations are permitted to be performed on each of the memory modules. One should note that this restriction may be overridden in cases where the number of writes or erases exceeds the long-term capability of the memory module as configured. However, for purposes of explanation, such a condition is not described.

Each of the memory modules may have a plurality of memory packages (for example plastic package containing one or more chips and interface pins, which may be a dual in-line package, Ball Grid Array (BGA) or the like). Again, for simplicity, we assume that an entire memory module is coordinated within the time domain of a Te or a Tw. That is, all of the memory circuits in the package act in a coordinated manner for purposes of determining whether a read, a write or and erase operation may be performed at a given time.

Where the data associated with an LBA has been processed, for example, into four strips of data and one parity strip (the sub-blocks), one of the strips may be written to each of the memory modules, so that a 4+1 RAID configuration results. As previously disclosed, the data and parity for that data may be read from any four of the five strips represent in the RAIDed LBA, and where one of the data strips is delayed or missing, the four strips (of the 5 strips in the stripe) that have returned information may be used either to represent the data, if the four strips were data strips, or three strips and the parity strip may be XORed to recover the fourth strip of the LBA data. So, if only one of the five memory modules is permitted to be in the Te or Tw window at any one time, there will always be four valid data strips immediately available for data access. Broadly, this is the concept known as “erase (or write) hiding”, but this description is not intended to be a limitation on the subject matter herein or of any other patent or patent application.

In some embodiments, a read request to a memory module that is in the Te or Tw window may be executed if there is no pending write or erase operation. If there is a pending write or erase operation, the read request may be queued so as to be performed at a later time. Unless the read operation is cancelled, or is permitted to time out, the operation will eventually be performed.

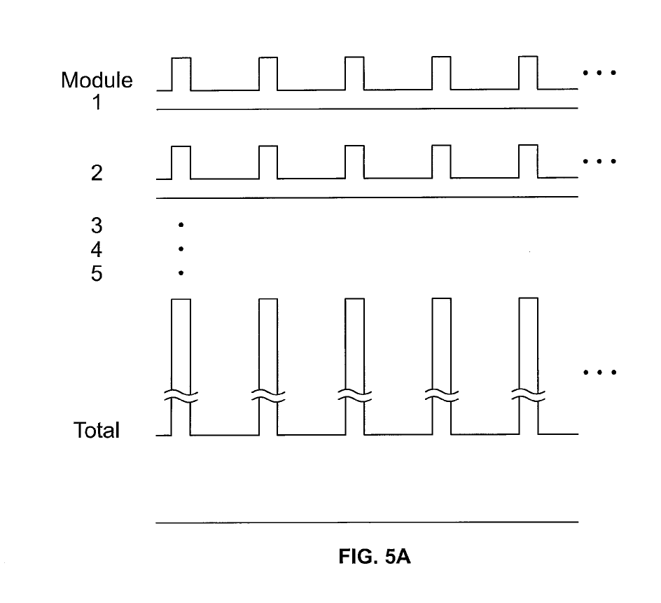

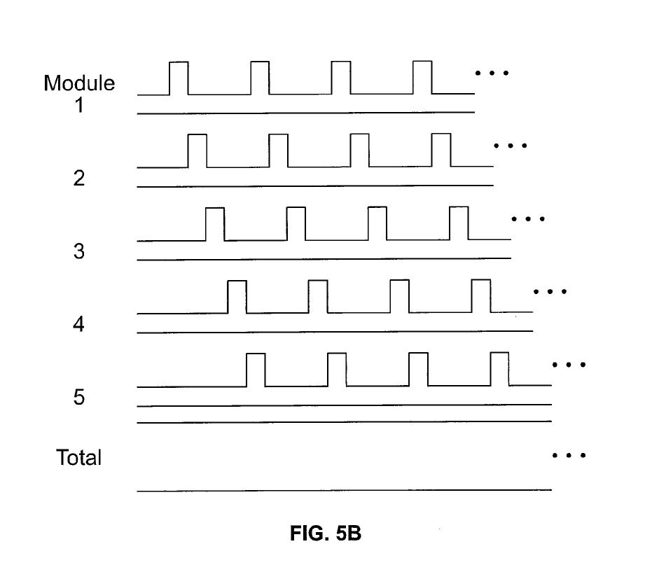

FIG. 5A, B is a schematic representation of the power consumption of the memory modules over one cycle of the sequence of erase windows Te. (For the moment we describe the erase window Te; however, a person of skill in the art would understand that the write window, Tw, would have similar properties. In some examples, the erase window may also be used for writes, so that the window time may be shared. The different time blocks are shown for conceptual purposes, as the relative time scales may differ with specific implementations. The energy required for a read, a write and an erase operation differs substantially, in about a ratio of 1:10:50, and the time over which this energy is expended is in a ratio of about 1:5:20. Different manufactures products, generations of products, and whether the data is stored as SLC, MLC or TLC affects these ratios and the absolute value of the energyneeded. However, the overall situation is conceptually similar.

FIG. 5A shows the power consumption of the five memory modules as a function of time, where the Te windows of each FLASH chip of a memory module coincide. The energy needed will vary from this simplistic representation, as operations, such as read or write operations may actually be performed over the entire time period excluding the Te, and erase operations may not actually be performed over the entire time period permitted by the Te, or each time an erase period is scheduled, as these execution of the operations depends on whether any such operations have been requested by the MC, the FTL or other system resources. The energy requirements for performing an erase or a write are greater than the power requirements for performing read operations. The operations of the five memory modules are coordinated in time in this example , and this coordination would result in a potential for two or more modules performing erase operations simultaneously, creating the condition known as “erase blockage.” The simultaneous erase operations also result in peaks in the overall power consumption. In principle, up to 5 times that of a single memory module, on a time scale of milliseconds. FIG. 5A shows a pathological but not prohibited configuration where all of the memory modules are erased simultaneously.

However, this situation is mitigated in the situation shown in FIG. 5B where the erase windows Te of the individual memory modules are coordinated so that only one of the five modules is permitted to perform an erase operation at any time. This configuration is typical of a simple example of a system coordinated to avoid erase or write blocking.

Often, there are erase windows, Te, for a memory module where an erase operation is not pending or being performed. In such a situation, pending read requests may be satisfied, if the system algorithms permit. Some of the erase windows may have have low power consumption (not the case shown) as they are not performing erases, but are performing reads. One may think of the energy pedestal that is shown as a horizontal line in FIG. 5 for each module as representing a mean energy requirement during periods where there is no erase operation in progress.

In a typical situation, as not all of the memory modules will be performing an erase operation (but may be performing write operations at lower energy), the periodic spikes in energy demand will have significantly more variability. The peak-to-average ratio is likely to result in the need for more substantial power supply and ground circuits and the prospect of electrical noise.

In an aspect, the power requirements of a memory array having a plurality of memory modules, where the memory modules may be organized as RAID groups may be managed by appropriate connection of a memory module from each of a plurality of RAID groups so as to depend on a particular power supply or power and ground bus. The erase time period window of each of the memory modules that are connected to a particular power source may be controlled such that the erase window time periods of the memory modules do not completely overlap. Where the erase times of the memory modules do not overlap, the cumulative peak power requirements of each of the groups of memory modules may be smoothed.

For example in a RAID architecture where there are 5 memory modules in a RAID group, one module from each of 5 RAID groups may be connected to a particular power bus or power supply. When the erase time periods of the 5 connected modules are configured so as not to overlap in time, then the effect of the erase power requirement is reduced as the erase window time periods do not overlap. Where more than 5 modules are connected to the same power bus, the configuration may use 10 modules selected from 10 RAID groups.

The memory modules may be configured to dismiss read requests received during an erase window Te. The dismissal could be with or without a status response to the RAID controller. That is, since the data from the first four modules to be received by the RAID controller may be used to recover the data, the data from the memory module in the erase window may not be needed and could be dismissed or ignored. Performing the read and reporting the data would not improve the latency performance. Rather, the energy and bus bandwidth used to perform the function have little overall benefit. Consequently, dismissing read requests received during the erase window of a memory module saves energy and bandwidth.

Alternatively, the RAID controller may be configured so as not to send read requests to a module that is in the erase window. This requires synchronization of the RAID controller operation with the timing of the erase windows, and may be more complex in the case where the duration of the erase window is adapted to account for the number of erase operations that are pending. However, such synchronization is feasible and contributes to overall system efficiency.

In another aspect, requests to perform an erase operation may be kept in a pending queue by the memory module controller at the memory module MM, and the pending requests performed during an erase window. So, some erase windows may have no operations being performed. Other erase windows may be used to perform pending write operations, and if there are read operations pending, they may be performed as well. Thus if a failure occurs in one of the other data strips (chunks) the delayed data can be sent with less latency when compared waiting for the full Te or Tw window time.

This may have some interesting implications with respect to write requests. A queue of write requests may be accumulated during the period of time between successive write/erase windows. The writes may not be performed during read operations so as to avoid write blockage. The interval between erase windows may be sized so that the number of writes that have been collected in the dynamic buffer on the memory module may be safely written to the non-volatile memory (FLASH) on the memory module in case there is an unscheduled shutdown. When a shutdown condition is identified (such as a drop in the supply voltage, or in the case of an orderly shutdown, a command received), the pending write data can be immediately written to the non-volatile memory so as to avoid data loss. The data read, but not as yet reported, may be lost, but the system is shut down and the data will be of little value.

The write queue may contain the data that arrived during the read operations of the memory module. The system may be configured so that the pending write operations are executed during the next write/erase window. Alternatively, not all of the pending write operations may not be performed, so that write data is still queued in the memory module dynamic buffer at the end of a write interval. As has been indicated, this queue buffer size is limited only by the size of the dynamic buffer of the design and the amount of data that can be written to the non-volatile memory during the shut-down time. The power reserve to do this could be merely the slow decay of the power supply voltage, or stored in a supercapacitor, or a battery, as examples.

There are situations where repetitive writes are performed to a particular LBA. The time interval between such writes is determined by the user, and in a pathological case, the user may continually request writes to a specific LBA. If all of the requests were honored, the memory system would be inefficiently used. As has been described, the NAND flash memory has the characteristic that a memory cell must be erased before new data can be written to that physical memory location. So, when data is written to a LBA (for example, when the data in the LBA is modified), the FTL acts to allocate a new physical address (PBA) to which the data is written, even though the LBA is the same, while the data in the old physical address becomes invalid.

A continuous series of write operations to a single LBA would results in continual allocation of a new physical address for each write, while the old physical addresses become invalid. Before the old physical addresses are again available for writing, the block containing the PBAs needs to be erased. So, repetitive writes to a single LBA would increase the rate of usage of unwritten PBAs with a consequent increase in the rate of garbage collection activities and block erases. Maintaining a queue of pending writes may serve to mitigate this problem. The most recent pending write would remain in the queue and serve also as a read cache for the LBA. Thus, a subsequent read to the same address will return the most recent data that has been loaded to the write queue memory. Write operations that have become obsolete prior to commitment to the NAND flash may be therefore be dismissed without having been executed if the data in the LBA is being changed.

Erase operations may be deferrable. That is, as part of the housekeeping function, the erase operation may not need to be performed promptly. An erase operation results in the erasure of a block, which may be, for example, 128 pages (LBAs). So, the number of erase operations is perhaps 2 percent of the number of write operations (assuming some write amplification), although the time to perform the erase is perhaps 5-10 times longer than a write operation. Since the current approach to architecting a FLASH memory system is to overprovision the memory, a temporary halt to erase operations may be possible without running out of free memory areas to write new or relocated data. So, in situations where the temperature of the memory array exceeds a limit, due to any cause, erase windows may be inhibited from performing erase operations, and perhaps even write operations, as each of these operations consumes more power than an equivalent read operation. Eventually these operations will have to be performed, except for obsolete writes, so as to bring the supply of free memory areas back into balance with the demand for free memory. However, if the remainder of the garbage collection operations has been performed on at least some of the blocks of memory, only an erase operation needs to be performed on the block so as to free the entire block. An erase operation may be deferred to facilitate performance on another higher priority or higher perceived operation.

Operating a large memory array subjects the memory array to a variety of operating conditions, and during certain period of a day, the array may perform considerably more read operations than write operations. Conversely, there may be periods where large data sets are being loaded into the memory, and write operations are much more frequent. Since many applications of memory systems are for virtualized systems, portions of the memory array may be in an excess read condition, and portions of the memory array may be in an excess write or excess garbage collection condition. Consequently, there are circumstances where, the erase operations may be deferred so as to occur when the memory system is not performing real-time write operations. So, while the overall power consumption may not change over a diurnal cycle, the peak power demands of the system may be leveled. This may be helpful in avoiding hot spots in the equipment and reducing the peak cooling demand.

In yet another aspect, the management of writing or erasing of a memory device may also be controlled at a smaller scale so as to efficiently read and write to the non-volatile memory.

In common with many high-density electronic circuits flash memory devices are limited in input/output capability by the number of pins or other connections that may be made to a single package. The usual solution is to multiplex the input or output. For example data on a parallel bus having a width of 32 bits may be represented by 4 bytes of data loaded sequentially over an 8 bit wide input/output interface. The effect of this constricted interface bandwidth on device operation may depend on the functions performed by the device.

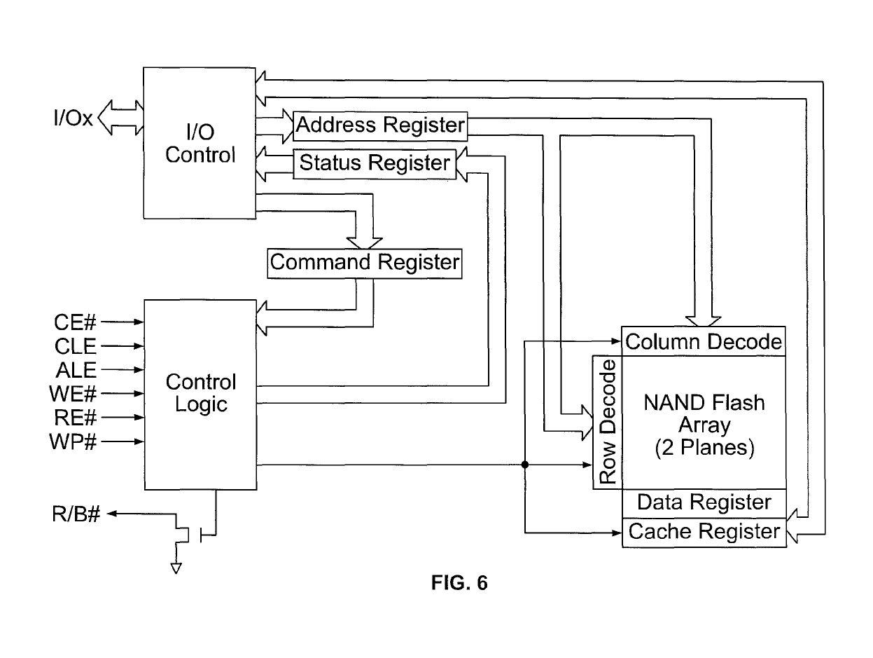

FIG. 6 shows a simplified block diagram of a NAND flash memory chip, where the data and command interface is multiplexed so as to accommodate a limited number of interface connections. Internally the address data is resolved into row and column addresses and used to access the NAND flash array. A memory package may have a plurality of chips, and each chip may have two planes. The planes may be operated independently of each other, or some operations may be performed simultaneously by both planes. The data are transferred to or from the NAND Flash memory array, byte by byte (x8), through a data register and a cache register. The cache register is closest to I/O control circuits and acts as a data buffer for the I/O data, whereas the data register is closest to the memory array and acts as a data buffer for the NAND Flash memory array operation. The five command pins (CLE, ALE, CE#, RE#, WE#) implement the NAND Flash command bus interface protocol. Additional pins control hardware write protection (WP#) and monitor device status (R/B#).

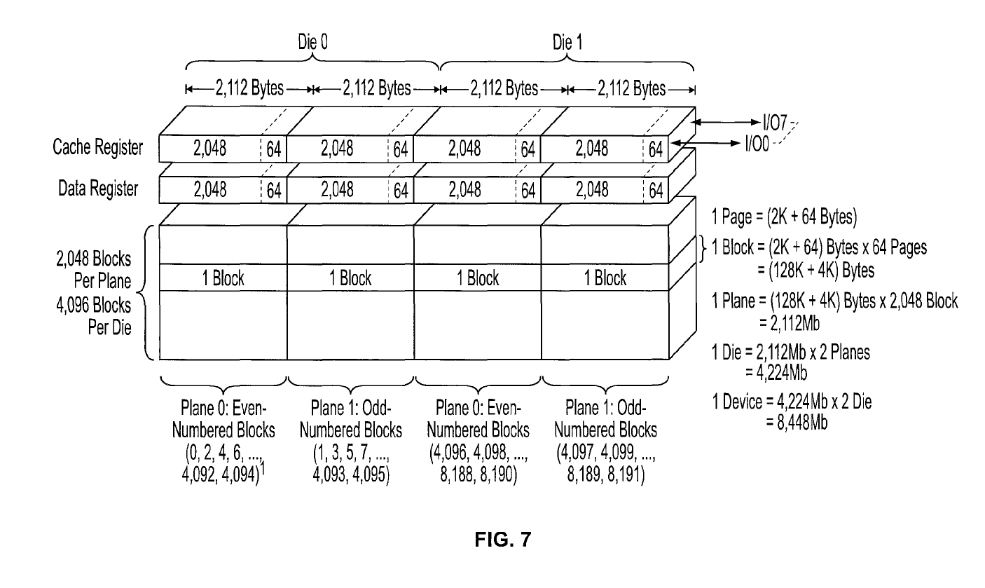

FIG. 7 shows a representation of a NAND flash memory that is comprised of two die, each die having two planes. A die is the minimum sized hardware unit that can independently execute commands and report status. The description of a flash memory circuit and the nomenclature may differ between manufacturers; however, a person of skill in the art would understand that the concepts pertain to the general aspects of a NAND flash memory, for example, and are not particularly dependent on the manufacturer as to concept. As may be seen, the data received at the interface in FIG. 7 is transmitted over a bus to the cache register on an appropriate chip and plane thereof. The internal bus may be limited, as shown, to a width of 8 bits; and, the bytes of the page to be written may be transmitted in byte-serial fashion. Moreover, the internal bus may service both planes of a die, so that while data may be read or written to the two planes of a die independently, the data transport between the package I/O interface and the chip may be a shared bi-directional bus.

The limited number of pins on the package containing a plurality of die is a constraint on the speed with which the device can respond to a read or a write command. For this discussion, the data bus width is presumed to be 8 bits, regardless of the number of chips in the package. Internal to the package, the data bus architecture may be be shared for both read data and write data, so that the total bandwidth of the device may be limited to that of the 8 bit bus, as reduced by any overhead encountered. For simplicity, the overhead is neglected in this discussion. Packages with four chips are used today, but in an effort to increase packaging density without further reducing device feature sizes, a larger number of chips may be included in a single package, the cells of a die may be stacked, or other means of increasing the density used,including three dimensional memory structures. Each of these approaches may lead to a further increase of the amount of data that may need to be accommodated by the package interface or the internal busses.

As has been previously described, the internal bus architecture of flash memory chips is usually multiplexed as, ultimately, the memory package interface with the remainder of the remainder of the system may be limited to, for example a byte-width interface. As such, the transmission of data to the individual chips for writing in the package may be effectively serialized. The same situation may occur for reading of data from the chip.

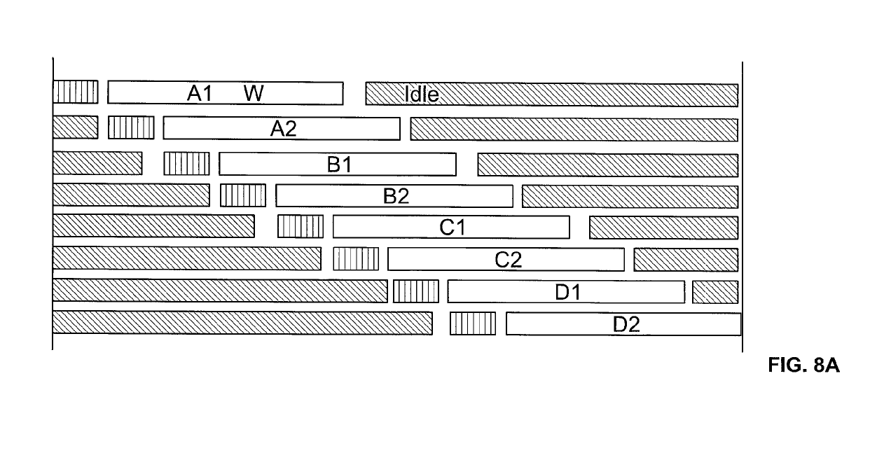

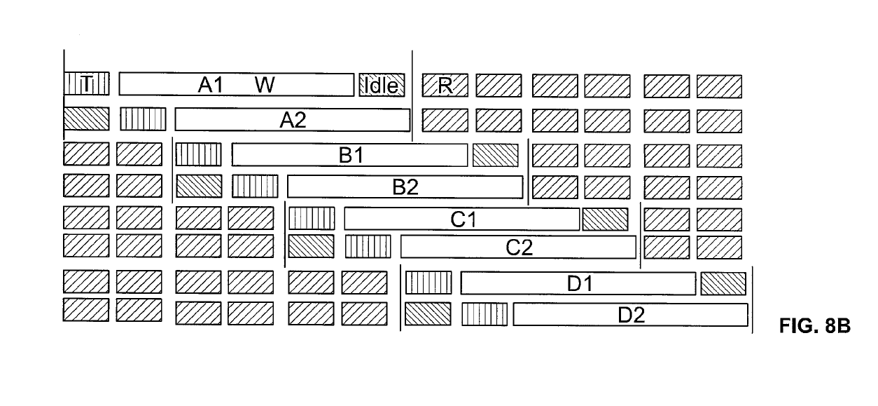

FIG. 8 shows a conceptual timing diagram for a memory device or package the may contain, for example, 4 chips (A-D), each chip being a die with two planes. The planes may be read or written to independently. Typically a write operation comprises a transfer of data (T) from the package interface controller to the cache or buffer register on the plane of a die to be written, followed by writing (W) the data to the selected physical memory location on the plane. During that time, no other operations are performed on the plane of the die. Depending on the design of the flash circuit, the other plane of the die may be available for writing of reading of data.

Since the two planes of a die often share a bus connection between the die and the package controller, the transfer of data for writing to the second of the two planes may be blocked when data is being transferred to the first plane. However, when the first plane is writing data, the data may be transferred from the interface controller to the second plane cache, followed by a write to the second plane of the die. There exists a period of overlap between the write operations on the first and the second plane of a die in this situation, and no other operations may be performed on the die. This means that the die is not using the bus connection to the package controller, and the bus may be used to communicate data to or from another die. In the present example, the same sequence of data transfer, followed by write operations, may be performed on planes B1 and B2, and so on. For the purposes of this example, we have assumed that data was available for writing to all of the planes of the dies of the package. So, this may represent a maximum write density situation. Where less than the maximum write rate is needed, only the planes to which data is being directed are involved. Writing data in a rapid burst to a memory package is useful when the time period when writing of data is permitted is controlled for other purposes.

One notes, however, that for each of the planes, there are periods of time where the plane is not performing write operations, yet some plane of the memory package is performing a write operation. The bus connecting the planes of the chips with the package controller may be unused during these time periods. This may permit the plane or the chip to be placed in a lower power state so as to conserve energy. A lack of read capability in this circumstance may not be detrimental to read latency when “erase (write) hiding” techniques, are employed.

Depending to the operation of the memory management system, a memory controller managing one or more memory circuits may be controlled such that write operations are only permitted during specific time periods. Where erase hiding is used, other memory circuits, having a sufficient portion of the data (including parity data) may be available such that the stored data may be recovered without blockage due to the write or erase operation.

When the operation is an erase operation, it is typical that a block of memory on a plane of the memory is erased. When performing such an erase operation, which takes longer than a write operation, neither write nor read operations may be performed. The data bus is not used for an erase operation, and the overall effect at the system level is comparable to a write operation in terms of blocking of a read operation, although the time duration of an erase operation is longer than a write operation. There are fewer erase operations than write operations, as a block comprises, for example, 128 pages, which are erased in a single erase operation.

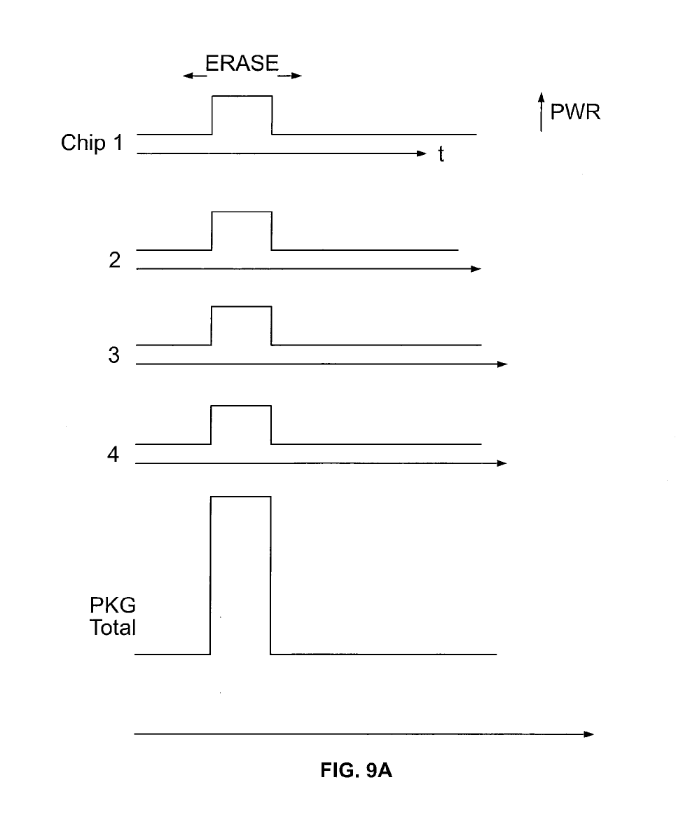

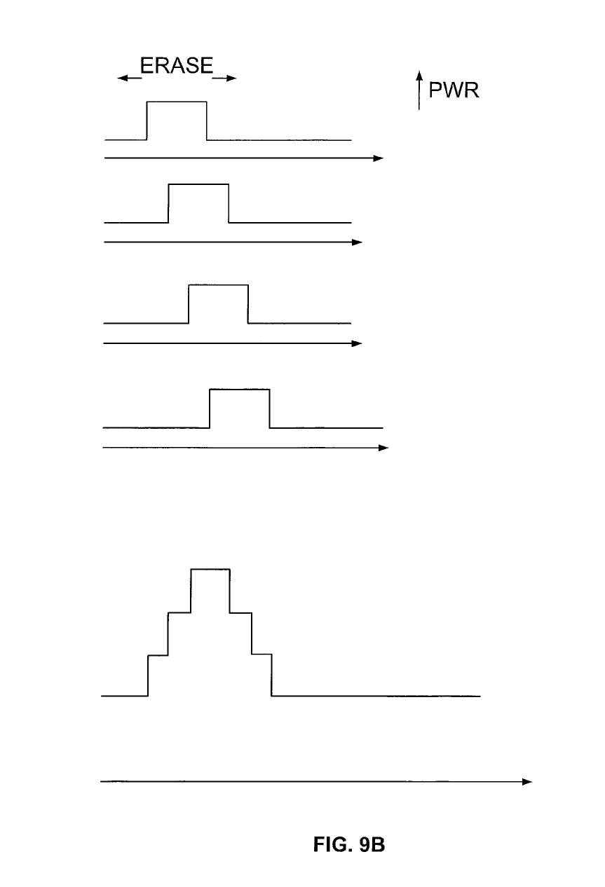

When performing an erase operation during a scheduled time period, erasing of all of the chips at one time would result in the power requirements shown in FIG. 9A. Since all of the power may be supplied through a single interface to the device package, this places a significant peak load on the traces, and must be accommodated in the design. Alternatively, packages may have constraints on the number of chips that may be in an erase state at one time. FIG. 9B shows a planned sequence of erase operations on the different chips of the device so that the peak power and the rate of change of power requirements is reduced. This somewhat lengthens the overall time that the device is in an erase window. However, as described above, the chips that are not performing an erase operation may be controlled so as to write data or to read data for either user needs or housekeeping. Since the energy requirements for reading and writing are considerably smaller than that needed for erase operations, so the overall power profile would be similar to that shown in FIG. 9B.

So, while erase or write operations are being performed, only a portion of the memory package is not available for read operations. Alternatively, a portion of the memory package may be put in a low power state so as to minimize overall power consumption when read operations are not needed to be performed in an overlapped manner with erases or writes.

In another aspect, read operations may be performed on die in a package that is not being erased or written to. Such read operations may be performed on the die that are not blocked by write or erase operations, and may use the bus capacity that is available. In particular, such read operations may be used for background read operations as may be used in garbage collection or similar system housekeeping operations. User read requests may also be serviced, depending on the system configuration.

In yet another aspect, the read requests for a RAID stripe may be received at a plurality of memory controllers and may include read requests for all of the data and the parity data. One of the memory circuits of memory circuits storing the data for which the read request was made may be performing a write or erase operation during a time window reserved for that operation. The other memory circuits may be read and provide all of the information (data, or partial data and parity) needed to complete the read operation on the RAID stripe. As such, the read request for the remaining data has been overtaken by events and the information is no longer needed. A command dismissing the outstanding read request may be issued and, providing that the read request has not yet been performed, the request is dismissed, thus saving both bandwidth and power. Since the usual situation is that all of the data and the parity data is not needed to perform the read operation for the data of a RAID stripe, one would expect the read request received by a memory controller during a write/erase window not to be needed, except if there were to be a memory failure. However, if the received read requests are performed promptly, the read request may have been performed if, for example, there is no write or erase operation in progress.

A time delay may be introduced into read requests received during an erase window, such that there is reasonable probability of the read request being cancelled before execution. A time delay, which may be of the order of 200 microseconds may be imposed prior to executing a read request that is received during an erase time window. The length of time of this delay window is dependent on the overall time scheduling of the system, and is used as an example.

So, a read request received during the erase window would remain pending for some time. The time is still short as compared with the length of the erase window, but permits the memory controller to issue a command cancelling the request if the information (data or parity) is no longer necessary to complete the reading of the data of a RAID stripe.

In an alternative, the RAID controller may be aware of the scheduling of the write/ erase windows, and only issue read requests to those memory circuits of the plurality of memory circuits where prompt read operations may be performed.

In either of these circumstances, the time periods that are not being used for write operations, or erase operations may, for example, be used for read operations that are in support of system housekeeping functions, such as garbage collection, or memory refresh. Such read operations may be performed without detailed coordination between modules, and may represent bulk data transfers that may be used, for example, to reconstruct a RAID stripe that has a failed memory and where the data stored on the memory chip currently in the write/erase time window can supply some of the needed data. In effect, these operations are not exposed to the user, and the timing of the completion of the operations is not as critical.

The selection of operating mode, from the plurality of operating modes that have been described, may be dependent on a policy that takes into account factors such as the current power consumption of the memory system, the ambient temperature, the temperature of an individual memory module, or the like, in order to better manage the long term operation of the memory system.

Such optimizations may change dynamically, as the memory system is subject to temporally dependent loads, arising from the various user needs. Booting virtual desktops, uploading large amounts of data, and on-line-transaction systems have different mixes of reads and writes, and are subject to varying usage patterns throughout the day. In a large memory system these differing load may affect different physical areas of the memory and may not be easily predicted or managed in detail, except through a power management strategy.

A time interval that may be used to replace the write or erase window may be used as a NOP window. Here, the intent is to reduce the current power consumption of a module, a portion of the storage system, or the entire storage system. The status of the module may be placed in the lowest power consumption state that is compatible with resuming operation in a desired time period. The NOP window does not increase the read latency, as the data is retrieved in the same manner as if a write or erase window is being used. Depending on the situation, a combination of write, erase and NOP windows may be used.

The NOP window is specifically intended to reduce current power consumption. This may be in response to a sensed increase in temperature of a module, of a portion of the storage system, or of the coolant. While using NOP windows may reduce the write bandwidth, and may result in deferring housekeeping operations, such reduction in system performance may be acceptable so as to maintain the overall integrity of the data and the functionality of a data center.

In yet another example, the data may be stored using RAID 6, which may result in 4 strips of data and 2 parity strips (P and Q). While the intent of this configuration is to protect the data against loss in the event of the failure of two modules, all of the data is only needed in that specific situation which is rare. So, a RAID stripe may have two of the modules subject to a write, erase or NOP window at any time, without increasing the read latency time. In read mostly situations, the RAID 6 configuration would use essential the same power as with the RAID configuration previously described. Alternatively, the windows may be used for system housekeeping operations.

In another aspect, the windows may be permissive and respond to parameters associated with a read or write command. Similarly, housekeeping-related commands may have parameters permitting the execution of the commands to be deferred, prioritized, dismissed, depending of the power status of the system or module. Alternatively, command may be parameterized so as to be executable without regard to the power status of the module.

In yet another aspect, the duration of a NOP window, for example, may be extended with respect to the duration of a read window.

It would be understood by a person of skill in the art that the device and method described herein may be of a scale size of the order of an integrated circuit package having a small number of chips, to a large system connected through high speed networks such as PCIe or the like. The RAID may stripe across memory chassis comprising multi terabytes of memory, which may be deployed across multiple racks or at distributed sites. The particular scheduling algorithms to be used would differ, but the objective would be to minimize instantaneous power variations or to temporarily manage the power consumption so as to address heat related problems. The benefit of these techniques would be realized with respect to the power distribution, bus bandwidth or heat management may be realized at the device level, chassis level, or at a system level. Doing this may involve managing of operations across a domain greater than the level in the system at which the benefit is obtained.

Although the present invention has been explained by way of the examples described above, it should be understood to the ordinary skilled person in the art that the invention is not limited to the examples, but rather that various changes or modifications thereof are possible without departing from the spirit of the invention.

What is claimed is:

1. A device comprising:
a controller configured to operate a memory device, further comprising:
a plurality of memory circuits, each memory circuit performing operations having at least a high power requirement and a low power requirement;
a group of the plurality of memory circuits selected to form a RAID group having erase hiding;
wherein two or more RAID groups configured such that a memory circuit performing a high power requirement operation in each RAID group is connected to power supply circuits such that the number of memory circuits performing overlapping high power operations and connected to a power supply circuit of the power supply circuits is limited.

2. The device of claim 1, wherein the high power operation is an erase or write operation performed by a FLASH memory circuit.

3. The device of claim 1, wherein the low power operation is a read operation performed by a FLASH memory circuit.

4. The device of claim 1, wherein the number of high power operations that completely overlap in time is limited.

5. The device of claim 1, wherein erase hiding comprises:
configuring the controller to:
write a stripe of data, including parity data for the data, to a group of memory circuits comprising a RAID group; and
read the stripe of data from the RAID group
wherein an erase operation performed on a memory block of a memory circuit of the RAID group memory is scheduled such that that sufficient data or parity data can be read from the memory circuits to return the data stored in the memory stripe of the RAID group in response to a read request without a time delay due to the erase operation.

6. The device of claim 5, wherein the erase operation is scheduled such that only one memory circuit of a stripe is performing an erase operation when single parity of the data is stored with the data.

7. The device of claim 6, wherein erase operations are scheduled such that two or less erase operations are scheduled when dual parity data is stored with the data.

8. The device of claim 1, wherein the high power operation is an erase operation and the low power operation is a read operation, a read request received by a memory circuit scheduled to permit an erase operation to be performed is delayed by a time period.

9. The device of claim 8, wherein the time period is a predetermined fraction of the scheduled erase period.

10. The device of claim 1, wherein the high power operation is an erase operation and the low power operation is a read operation, a read request received by a memory circuit scheduled to permit an erase operation to be performed is discarded.

11. A memory device comprising:
a controller configured to operate a memory device, further comprising:
a plurality of memory circuits, each memory circuit sharing a common bus between the controller and each of the plurality of memory circuits,
wherein a first memory circuit and a second memory circuit are controlled such that an operation performed on a first of the memory circuits is scheduled to permit transfer of data on the bus to a second memory circuit.

12. The memory device of claim 11, wherein the operation performed on the first memory circuit is one of an erase or a write operation, and the transfer of data to the second memory circuit is data to be subsequently written to the second memory circuit.

13. The memory device of claim 12, wherein the first memory circuit and the second memory circuit are a first plane of a FLASH memory circuit and a second plane of a FLASH memory circuit.

14. The memory device of claim 12, wherein a plurality of memory circuits share a common bus between the memory circuits and the controller and wherein the controller schedules the operations to be performed by the memory circuits such that transfer operations are performed a memory circuit during a time period when a first memory circuit is performing a erase or write information and the memory circuit to which the data is being transferred is not performing the erase or write information.

15. The memory device of claim 12, wherein the erase or write operations scheduled for the memory circuits of the plurality of memory circuits are scheduled such that a data transfer operation from the controller is permitted to each of the memory circuits of the plurality of memory circuits before a second erase or write operation is scheduled for any of the memory circuits sharing the bus.

16. The memory device of claim 15, wherein the bus is configured to transmit data from the memory circuits to the controller when the bus is not being used to transfer data to any of the memory circuits.

17. A memory device, comprising:
a controller configured to operate the memory device, further comprising:
a plurality of memory circuits, each memory circuit performing operations having at least a high power requirement and a low power requirement;
a group of the plurality of memory circuits selected to form a RAID group having erase hiding;
wherein the controller is operated to selectively inhibit operations of a memory circuits of the RAID group associated with the high power requirement

18. The device of claim 17, wherein the number of memory circuits of the RAID group having simultaneously inhibited operations is less than or equal to the number of redundant data blocks associated with a stripe of the RAID group.

19. A method of operating a memory device, comprising:
configuring a controller to operate a memory device, wherein the memory device comprises:
a plurality of memory circuits, each memory circuit performing operations having at least a high power requirement and a low power requirement; and
configuring a group of the plurality of memory circuits to form a RAID group having erase hiding;
configuring two or more RAID groups such that a memory circuit performing a high power requirement operation in each RAID group is connected to power supply circuits such that the number of memory circuits performing overlapping high power operations and connected to a power supply circuit of the power supply circuits is limited.

20. A computer program product, stored on a non-volatile media, comprising:
instructions configuring a controller to operate a memory device, wherein the memory device comprises:
a plurality of memory circuits, each memory circuit performing operations having at least a high power requirement and a low power requirement; and
configuring a group of the plurality of memory circuits to form a RAID group having erase hiding;
the controller further configuring two or more RAID groups such that a memory circuit performing a high power requirement operation in each RAID group is connected to power supply circuits such that the number of memory circuits performing overlapping high power operations and connected to a power supply circuit of the power supply circuits is limited.
